(19) United States
(12) Patent Application Publication
(10) Pub. No.: US 2016/0353097 A1
(43) Pub. Date: Dec. 1, 2016

(54) DISPLAY SWITCHABLE BETWEEN 2D AND 3D MODES AND CONTROL METHOD THEREOF

(71) Applicant: SHENZHEN CHINA STAR OPTOELECTRONICS TECHNOLOGY CO. LTD., Guangdong (CN)

(72) Inventor: Bin FANG, Shenzhen, Guangdong (CN)

(73) Assignee: Shenzhen China Star Optoelectronics Technology Co. Ltd., Shenzhen, Guangdong (CN)

(21) Appl. No.: 14/433,637

(22) PCT Filed: Dec. 30, 2014
(86) PCT No.: PCT/CN2014/095564

§ 371 Date: Apr. 3, 2015

(30) Foreign Application Priority Data
Dec. 3, 2014 (CN) 201410728146.8

(51) Int. Cl. H04N 13/04; G02F 1/29; G02B 27/26; G02B 27/22

(52) U.S. Cl. CPC H04N 13/0454; G02B 27/2214; G02F 1/29; H04N 13/0404; H04N 13/042; G02B 27/26; H04N 2213/001

(57) ABSTRACT

The present invention discloses a display switchable between 2D and 3D modes and a control method thereof. The display comprises a first lens panel, a first display panel, a second lens panel and a second display panel which sequentially stack-up, wherein the first lens panel and the second lens panel respectively comprise a first lens unit and a second lens unit aligned along a predetermined direction, and the first lens unit and the second lens unit can switch between a focused state, which can refract an entering light and a non focused state, which do not refract the entering light, wherein the first lens unit and the second lens unit stagger with each other along the predetermined direction. With the aforesaid arrangement, the present invention preferably improves the resolution and viewing angle of the display at the same time.

### FIELD OF THE INVENTION

The present invention relates to a display technology field, and more particularly to a display switchable between 2D and 3D modes and a control method thereof.

### BACKGROUND OF THE INVENTION

In recent years, the technology fields of the panel display and the related material have constantly been getting some progresses. The 3D display has become the focus of the people. Especially the naked eye 3D draws lots of attentions because the user does not need to wear any assistant equipments for watching the 3D result.

At present, two common ways are barrier 3D technology and lenticular lens technology.

The achievement of the barrier 3D technology is to utilize a switch LCD screen, a polarizing film and a polymer liquid crystal layer. With the liquid crystal layer and the polarizing film, a series of 90° vertical strips is created. The widths of these strips are scores of micrometers. The light passing through them forms a vertical thin gate mode, so called “parallax barrier”. The technology utilizes the parallax barrier located between the backlight module and the LCD panel. Under the 3D display mode, when the image which should be seen by the left eye is shown on the LCD screen, the opaque strips blocks the right eye; similarly, when the image which should be seen by the right eye is shown on the LCD screen, the opaque strips blocks the left eye. By separating the visual images of the left eye and the right eye, the audience can see the 3D images. The advantage of such technology is the cost merit. However, the screen brightness of the screen using such technology is lower.

Lenticular lens technology is also named as micro lens 3D technology. The image plane of the LCD screen is positioned on the focal plane of the lens. Thereby, the pixel of the image under each lenticular lens is divided into several sub pixels. Thus, the lens can project each sub pixel toward different directions. The two eyes see the display screen from different angles, the different sub pixels are saw. The lenticular lens technology does not influence the screen brightness like the barrier technology does, and the display effect is better. However, if the focal length is f, and the lens pitch is p, and the gap between the lens and the display is g, and the image formation is at the position with a distance L in front of lens. Supposing that the resolution of the display is high enough, and the resolution of the image formation is: R=L/2 p, and the resolution unit is space frequency (1/rad); the viewing angle is: θ=2 arctan (p/2 g). The technical problem of the present technology is: when the p increases, and the viewing angle gets larger but the resolution of the image formation becomes small. It is very difficult to improve the resolution R and viewing angle θ of the display at the same time.

The traditional method for improving the resolution without descending the viewing angle is to utilize the way of lens moving: the lens is moved toward one direction (the distance is smaller than a lens pitch) and the display shows a corresponding element image (EI). Because of the visual staying phenomenon of the human eyes, the audience can see an enhanced resolution 3D image and the viewing angle does not change at this moment; the moving distance s of the lens array has to be smaller than the lens pitch p of the lens array. Generally, p/s=n which is an integer. If the lens only are moved horizontally, then the resolution at horizontal direction can be promoted (n times before the improvement); if the lens only are moved with a certain included angle f with the horizontal direction (the lens are moved in a slant way), then the resolution of the image formation in either horizontal and vertical directions can be promoted correspondingly. In the horizontal direction, the resolution is promoted with n×cos f times, and in the vertical direction, the resolution is promoted with n×sin f times. The traditional method employs the mechanical movement, which is difficult to be practically realized. The speed of the mechanical movement is fast and hard to control. During the mechanical movement, the accurate alignment between the lens array and the display can be more difficult to solve.

Consequently, there is a need to provide a display switchable between 2D and 3D modes and a control method thereof for solving the aforesaid technical problems.

### SUMMARY OF THE INVENTION

An objective of the present invention is to provide a display switchable between 2D and 3D modes and a control method thereof which preferably improves the resolution and viewing angle of the display at the same time.

For solving the aforesaid technical issue, the technical solution employed by the present invention is: providing a display switchable between 2D and 3D modes, wherein the display comprises a first lens panel, a first display panel, a second lens panel and a second display panel which sequentially stack-up, wherein the first lens panel and the second lens panel respectively comprise a first lens unit and a second lens unit aligned along a predetermined direction, and the first lens unit and the second lens unit can switch between a focused state, which can refract an entering light and a non focused state, which do not refract the entering light, wherein the first lens unit and the second lens unit stagger with each other along the predetermined direction, and a pitch of the first lens unit and the second lens unit along the predetermined direction are the same, and a staggered distance of the first lens unit and the second lens unit along the predetermined direction is a half of the pitch, and the display further comprises a control unit, and the control unit controls the display to alternately switch between a first state and a second state under the 3D mode, wherein in the first state, the first display panel is in a display state, and the first lens unit of the first lens panel is in the focused state to focus a element image displayed by the first display panel and project to an observer, and in the second state, the first display panel is in a transparent state, and the first lens unit of the first lens panel is in the non focused state, and the second display panel is in the display state, and the second lens unit of the second lens panel is in the focused state to focus a element image displayed by the second display panel for transmitting the focused element image through the first display panel and the first lens panel and projecting to the observer.

The first lens panel comprises a first transparent substrate, a second transparent substrate which are oppositely positioned, and a first liquid crystal layer packaged between the first transparent substrate and the second transparent substrate, and the second lens panel comprises a third transparent substrate, a fourth transparent substrate which are oppositely positioned, and a second liquid crystal layer packaged between the third transparent substrate and the fourth transparent substrate, and the first transparent substrate is constructed by connecting a plurality of first curved structures which sections along the predetermined direction are arches, and the third transparent substrate is constructed by connecting a plurality of second curved structures which sections along the predetermined direction are arches, and the first curved structure and the second curved structure stagger along the predetermined direction, and both the first liquid crystal layer and the second liquid crystal layer comprise a plurality of liquid crystal molecules, and a first axis refractive index of the liquid crystal molecules is larger than refractive indexes of the first transparent substrate and the third transparent substrate, and a second axis refractive index of the liquid crystal molecules is equal to the refractive indexes of the first transparent substrate and the third transparent substrate.

Widths of the first curved structure and the second curved structure along the predetermined direction are equal, and a staggered distance of the first curved structure and the second curved structure along the predetermined direction is a half of the width.

The control unit controls the first display panel to be in the display state, and the first lens unit of the first lens panel to be in the non focused state, or controls the first display panel to be in the transparent state, and the second display panel to be in the display state under 2D mode, and both the first lens unit of the first lens panel and the second lens unit of the second lens panel are in the non focused state.

The control unit is employed to control the liquid crystal molecules to twist, wherein as a first axis of the liquid crystal molecules is twisted to be parallel with the first display panel, the corresponding first lens unit or the corresponding second lens unit is in the focused state, and as the first axis of the liquid crystal molecules is twisted to be perpendicular with the first display panel, the corresponding first lens unit or the corresponding second lens unit is in the non focused state.

The display further comprises a first cell and a second cell, and the first cell is positioned between the first lens panel and the first display panel, and the second cell is positioned between the second lens panel and the second display panel, and the control unit respectively controls polarization states of polarized lights entering the first lens unit and the second lens unit by controlling the first cell and the second cell and accordingly, to control the first lens unit and the second lens unit to switch between the focused state and the non focused state.

For solving the aforesaid technical issue, another technical solution employed by the present invention is: providing a display switchable between 2D and 3D modes, wherein the display comprises a first lens panel, a first display panel, a second lens panel and a second display panel which sequentially stack-up, wherein the first lens panel and the second lens panel respectively comprise a first lens unit and a second lens unit aligned along a predetermined direction, and the first lens unit and the second lens unit can switch between a focused state, which can refract an entering light and a non focused state, which do not refract the entering light, wherein the first lens unit and the second lens unit stagger with each other along the predetermined direction.

A pitch of the first lens unit and the second lens unit along the predetermined direction are the same, and a staggered distance of the first lens unit and the second lens unit along the predetermined direction is a half of the pitch.

The first lens panel comprises a first transparent substrate, a second transparent substrate which are oppositely positioned, and a first liquid crystal layer packaged between the first transparent substrate and the second transparent substrate, and the second lens panel comprises a third transparent substrate, a fourth transparent substrate which are oppositely positioned, and a second liquid crystal layer packaged between the third transparent substrate and the fourth transparent substrate, and the first transparent substrate is constructed by connecting a plurality of first curved structures which sections along the predetermined direction are arches, and the third transparent substrate is constructed by connecting a plurality of second curved structures which sections along the predetermined direction are arches, and the first curved structure and the second curved structure stagger along the predetermined direction, and both the first liquid crystal layer and the second liquid crystal layer comprise a plurality of liquid crystal molecules, and a first axis refractive index of the liquid crystal molecules is larger than refractive indexes of the first transparent substrate and the third transparent substrate, and a second axis refractive index of the liquid crystal molecules is equal to the refractive indexes of the first transparent substrate and the third transparent substrate.

Widths of the first curved structure and the second curved structure along the predetermined direction are equal, and a staggered distance of the first curved structure and the second curved structure along the predetermined direction is a half of the width.

The display further comprises a control unit, and the control unit controls the display to alternately switch between a first state and a second state under the 3D mode, wherein in the first state, the first display panel is in a display state, and the first lens unit of the first lens panel is in the focused state to focus a element image displayed by the first display panel and project to an observer, and in the second state, the first display panel is in a transparent state, and the first lens unit of the first lens panel is in the non focused state, and the second display panel is in the display state, and the second lens unit of the second lens panel is in the focused state to focus a element image displayed by the second display panel for transmitting the focused element image through the first display panel and the first lens panel and projecting to the observer.

The control unit controls the first display panel to be in the display state, and the first lens unit of the first lens panel to be in the non focused state, or controls the first display panel to be in the transparent state, and the second display panel to be in the display state under 2D mode, and both the first lens unit of the first lens panel and the second lens unit of the second lens panel are in the non focused state.

The display further comprises a control unit, and the control unit is employed to control the liquid crystal molecules to twist, wherein as a first axis of the liquid crystal molecules is twisted to be parallel with the first display panel, the corresponding first lens unit or the corresponding second lens unit is in the focused state, and as the first axis of the liquid crystal molecules is twisted to be perpendicular with the first display panel, the corresponding first lens unit or the corresponding second lens unit is in the non focused state.

The display further comprises a control unit, a first cell and a second cell, and the first cell is positioned between the first lens panel and the first display panel, and the second cell is positioned between the second lens panel and the second display panel, and the control unit respectively controls polarization states of polarized lights entering the first lens unit and the second lens unit by controlling the first cell and the second cell and accordingly, to control the first lens unit and the second lens unit to switch between the focused state and the non focused state.

For solving the aforesaid technical issue, another technical solution employed by the present invention is: providing a control method of a display switchable between 2D and 3D modes, wherein the display comprises a first lens panel, a first display panel, a second lens panel and a second display panel which sequentially stack-up, wherein the first lens panel and the second lens panel respectively comprise a first lens unit and a second lens unit aligned along a predetermined direction, and the first lens unit and the second lens unit can switch between a focused state, which can refract an entering light and a non focused state, which do not refract the entering light, wherein the first lens unit and the second lens unit stagger with each other along the predetermined direction, and the method comprises: controlling the display to alternately switch between a first state and a second state, wherein in the first state, the first display panel is in a display state, and the first lens unit of the first lens panel is in the focused state to focus a element image displayed by the first display panel and project to an observer, and in the second state, the first display panel is in a transparent state, and the first lens unit of the first lens panel is in the non focused state, and the second display panel is in the display state, and the second lens unit of the second lens panel is in the focused state to focus a element image displayed by the second display panel for transmitting the focused element image through the first display panel and the first lens panel and projecting to the observer.

The control method further comprises: controlling the first display panel to be in the display state, and the first lens unit of the first lens panel to be in the non focused state, or controls the first display panel to be in the transparent state, and the second display panel to be in the display state, and both the first lens unit of the first lens panel and the second lens unit of the second lens panel are in the non focused state.

The benefits of the present invention are: different from prior arts, the present invention arranges that the first lens panel and the second lens panel respectively comprise the first lens unit and the second lens unit aligned along a predetermined direction, and controls the first lens unit and the second lens unit to switch between the focused state, which can refract the entering light and the non focused state, which do not refract the entering light, and sets the first lens unit and the second lens unit to stagger with each other along the predetermined direction. The resolution and viewing angle of the display can be preferably improved at the same time.

### BRIEF DESCRIPTION OF THE DRAWINGS

FIG. 1 is a top view structural diagram of a display switchable between 2D and 3D modes according to the present invention;

FIG. 2 is a sectional diagram of the display switchable between 2D and 3D modes shown in FIG. 1 along the predetermined direction A-A according to the preferred embodiment of the present invention;

FIG. 3 is a diagram of the long axis and the short axis of liquid crystal molecules shown in FIG. 2;

FIG. 4 is a backward diagram of the liquid crystal molecules of the display when the first lens unit or the second lens unit is in non focused state according to the preferred embodiment of the present invention;

FIG. 5 is a backward diagram of the liquid crystal molecules of the display when the first lens unit or the second lens unit is in focused state according to the preferred embodiment of the present invention;

FIG. 6 is a sectional diagram of the display switchable between 2D and 3D modes shown in FIG. 1 along the predetermined direction A-A according to another preferred embodiment of the present invention;

FIG. 7 is a flowchart of a control method of a display switchable between 2D and 3D modes according to the preferred embodiment of the present invention.

### DETAILED DESCRIPTION OF PREFERRED EMBODIMENTS

The present invention will be further described in detail with the accompanying drawings and the specific embodiments.

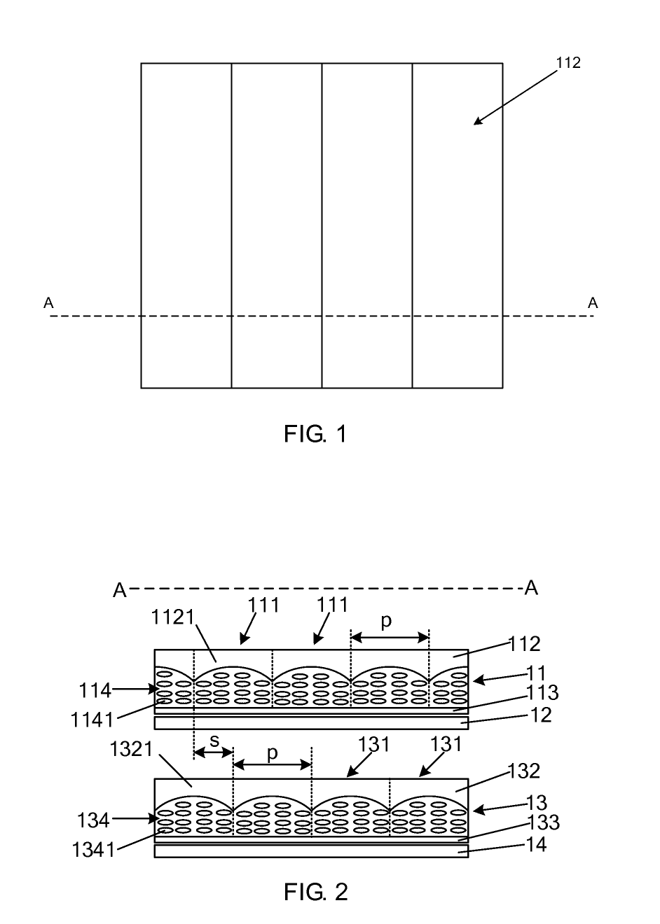

Please refer to FIG. 1. FIG. 1 is a top view structural diagram of a display switchable between 2D and 3D modes according to the present invention; FIG. 2 is a sectional diagram of the display switchable between 2D and 3D modes shown in FIG. 1 along the predetermined direction A-A according to the preferred embodiment of the present invention.

In this embodiment, the display comprises a first lens panel 11, a first display panel 12, a second lens panel 13 and a second display panel 14 which sequentially stack-up. Preferably, the first lens panel 11, the first display panel 12, the second lens panel 13 and the second display panel 14 are positioned in parallel with one another, and the first lens panel 11, the first display panel 12, the second lens panel 13 and the second display panel 14 are positioned in sequence from top to bottom.

The first lens panel 11 and the second lens panel 13 respectively comprise a first lens unit 111 and a second lens unit 113 aligned along a predetermined direction A-A. The first lens panel 11 comprises a plurality of first lens units 111 aligned along the predetermined direction A-A. The second lens panel 13 comprises a plurality of second lens unit 113 aligned along the predetermined direction A-A.

The first lens unit 111 and the second lens unit 113 can switch between a focused state, which can refract an entering light and a non focused state, which do not refract the entering light, wherein first lens unit 111 and the second lens unit 113 stagger with each other along the predetermined direction A-A. Preferably, a pitch p of the first lens unit 111 and the second lens unit 113 along the predetermined direction A-A are the same and a staggered distance of the first lens unit 111 and the second lens unit 113 along the predetermined direction A-A is a half of the pitch p.

Preferably, the first lens panel 11 comprises a first transparent substrate 112, a second transparent substrate 113 which are oppositely positioned, and a first liquid crystal layer 114 packaged between the first transparent substrate 112 and the second transparent substrate 113, and the second lens panel 13 comprises a third transparent substrate 132, a fourth transparent substrate 133 which are oppositely positioned, and a second liquid crystal layer 134 packaged between the third transparent substrate 132 and the fourth transparent substrate 133, and the first transparent substrate 112 is constructed by connecting a plurality of first curved structures 1121 which sections along the predetermined direction A-A are arches, and the third transparent substrate 132 is constructed by connecting a plurality of second curved structures 1321 which sections along the predetermined direction A-A are arches, and the first curved structure 1121 and the second curved structure 1321 stagger along the predetermined direction A-A. Significantly, in this embodiment, the first liquid crystal layer 114 is package between the first transparent substrate 112 and the second transparent substrate 113. In other embodiments, the first lens pane 111 can merely comprise the first transparent substrate 112 without the second transparent substrate 113. Under such circumstance, the first liquid crystal layer 114 is package between the first display panel 12 and the first transparent substrate 112. Similarly, the second liquid crystal layer 134 can be directly packaged between the second display panel 14 and the third transparent substrate 132. Thus, the third transparent substrate 132 can merely comprise the third transparent substrate 132 without the fourth transparent substrate 133.

Preferably, widths p of the first curved structure 1121 and the second curved structure 1321 along the predetermined direction A-A are equal, and a staggered distance s of the first curved structure 1121 and the second curved structure 1320 along the predetermined direction A-A is a half of the width p.

Preferably, the display further comprises a control unit (not shown). The controls the display to alternately switch between a first state and a second state under the 3D mode, wherein in the first state, the first display panel 12 is in a display state, and the first lens unit 111 of the first lens panel 11 is in the focused state to focus a element image displayed by the first display panel 111 and project to an observer; in the second state, the first display panel 12 is in a transparent state, and the first lens unit 111 of the first lens panel 11 is in the non focused state, and the second display panel 14 is in the display state, and the second lens unit 131 of the second lens panel 13 is in the focused state to focus a element image displayed by the second display panel 14 for transmitting the focused element image through the first display panel 12 and the first lens panel 11 and projecting to the observer. Because the staggered distance s of the first curved structure 1121 and the second curved structure 1320 along the predetermined direction A-A is a half of the width p, the resolution of the display at the horizontal direction can be raised with p/s times. Preferably, the resolution can be doubled.

Preferably, the control unit controls the first display panel 12 to be in the display state, and the first lens unit 111 of the first lens panel 11 to be in the non focused state, or controls the first display panel 12 to be in the transparent state, and the second display panel 13 to be in the display state under 2D mode, and both the first lens unit 111 of the first lens panel 11 and the second lens unit 131 of the second lens panel 13 are in the non focused state.

Both the first liquid crystal layer 114 and the second liquid crystal layer 134 comprise a plurality of liquid crystal molecules. The first liquid crystal layer 114 comprises a plurality of liquid crystal molecules 1141. The second liquid crystal layer 134 comprises a plurality of liquid crystal molecules 1341.

Preferably, the control unit is employed to control the liquid crystal molecules 1141, 1341 to twist, wherein as a first axis X of the liquid crystal molecules 1141, 1341 is twisted to be parallel with the first display panel 12, the corresponding first lens unit 111 or the corresponding second lens unit 131 is in the focused state, and as the first axis X of the liquid crystal molecules 1141, 1341 is twisted to be perpendicular with the first display panel 12, the corresponding first lens unit 111 or the corresponding second lens unit 113 is in the non focused state.

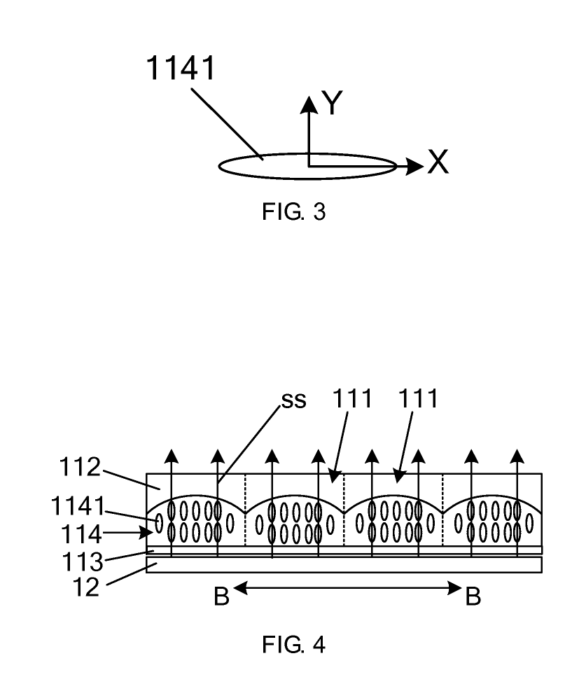

Please refer to FIG. 3. FIG. 3 is a diagram of the long axis and the short axis of liquid crystal molecules shown in FIG. 2. A first axis X refractive index nₑ of the liquid crystal molecules 1141, 1341 is larger than refractive indexes nₒ of the first transparent substrate 112 and the third transparent substrate 132, and a second axis Y refractive index nₒ of the liquid crystal molecules 1141, 1341 is equal to the refractive indexes nₒ of the first transparent substrate 112 and the third transparent substrate 113. The first axis X refractive index nₑ of the liquid crystal molecules 1141, 1341 is the refractive index to the light when the light direction is perpendicular with the first axis X. The second axis Y refractive index nₒ of the liquid crystal molecules 1141, 1341 is the refractive index to the light when the light direction is perpendicular with the second axis Y. The liquid crystal molecules 1141, 1341 possess a long axis and a short axis. Preferably in this embodiment, the first axis X of the liquid crystal molecules 1141, 1341 is the long axis. The second axis Y is the short axis. The refractive indexes on these two axes are not equal. Hypothetically, the refractive index on the long axis is nₒ and the refractive index on the short axis is nₒ. nₑ>nₒ is illustrated for explanation, which only refers to the liquid crystal molecules 1141 in FIG. 3. It is understandable that the liquid crystal molecules 1341 and the liquid crystal molecules 1141 are similar.

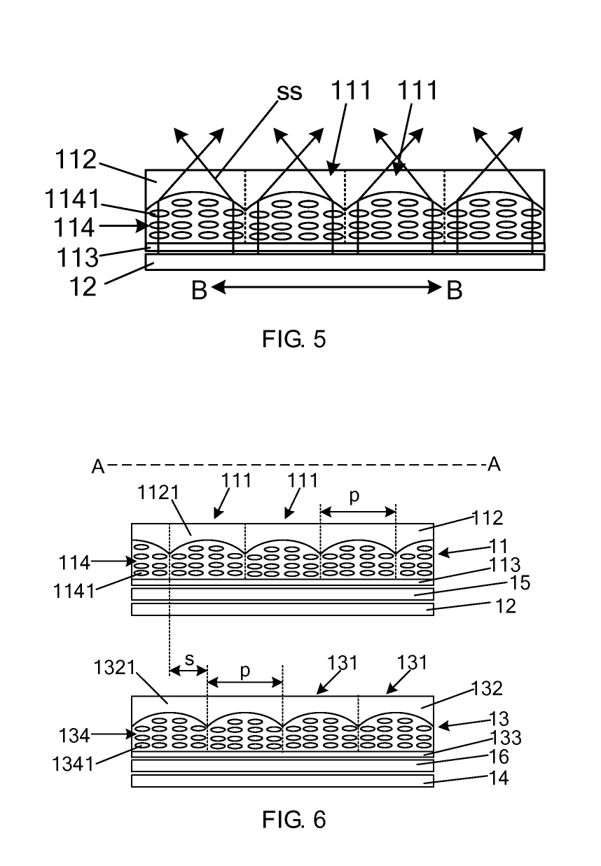

Please refer to FIG. 4 and FIG. 5. FIG. 4 is a backward diagram of the liquid crystal molecules of the display when the first lens unit or the second lens unit is in non focused state according to the preferred embodiment of the present invention. FIG. 5 is a backward diagram of the liquid crystal molecules of the display when the first lens unit or the second lens unit is in focused state according to the preferred embodiment of the present invention. In this embodiment, the positive liquid crystal molecules are illustrated (the negative liquid crystal molecules are similar). FIG. 4 is the condition that the control unit does not apply voltages (no electric field is generated between the first transparent substrate and the second transparent substrate, and similarly, no electric field is generated between the third transparent substrate and the fourth transparent substrate). Now, the long axes of the liquid crystal molecules 1141, 1341 are aligned along the direction perpendicular with the first display panel 12. When the polarization state of the entering polarized light is the horizontal direction B-B as shown in FIG. 4, the refractive index of the first liquid crystal layer 114 or the second liquid crystal layer 134 to the entering light ss is nₒ and the refractive index of the first transparent substrate 112 or the third transparent substrate 132 is nₒ as the same. Because the refractive index does not change on the propagation direction of the entering light ss, the entering light ss will not be refracted. The first lens unit 111 or the second lens unit 131 does not form the lens focus. That is, the first lens unit 111 or the second lens unit 131 is not in the focus state; FIG. 5 is the condition that the control unit applies voltages (a electric field is generated between the first transparent substrate and the second transparent substrate, and similarly, a electric field is generated between the third transparent substrate and the fourth transparent substrate). Now, the long axes of the liquid crystal molecules 1141, 1341 are aligned along the direction parallel with the first display panel 12. When the polarization state of the entering polarized light is the horizontal direction B-B as shown in FIG. 5, the refractive index of the first liquid crystal layer 114 or the second liquid crystal layer 134 to the entering light ss is nₑ and the refractive index of the first transparent substrate 112 or the third transparent substrate 132 is nₒ and nₑ>nₒ. the light will be refracted and the lens focus is formed. That is, the first lens unit 111 or the second lens unit 131 is in the focus state. Only the liquid crystal molecules 1141 are illustrated for explanation in the foregoing FIG. 4 and FIG. 5. It is understandable that the corresponding liquid crystal molecules 1341 are similar.

Please refer to FIG. 6. FIG. 6 is a sectional diagram of the display switchable between 2D and 3D modes shown in FIG. 1 along the predetermined direction A-A according to another preferred embodiment of the present invention. The difference of this embodiment from the aforementioned embodiments is that the display further comprises a first cell 15 and a second cell 16, and the first cell 15 is positioned between the first lens panel 11 and the first display panel 12, and the second cell 16 is positioned between the second lens panel 13 and the second display panel 14, and the control unit respectively controls polarization states of polarized lights entering the first lens unit 111 and the second lens unit 131 by controlling the first cell 15 and the second cell 16 and accordingly, to control the first lens unit 111 and the second lens unit 131 to switch between the focused state and the non focused state. Preferably, the first cell 15 and the second cell 16 are TN cells, and are parallel with the first display panel 12 and the second display panel 14. In this embodiment, the liquid crystal molecules 1141, 1341 do not need to twist for realizing the switch of the first lens unit 111 and the second lens unit 131 between the focused state and the non focused state. Preferably, the long axes of the liquid crystal molecules 1141, 1341 are aligned along the direction parallel with the first display panel 12.

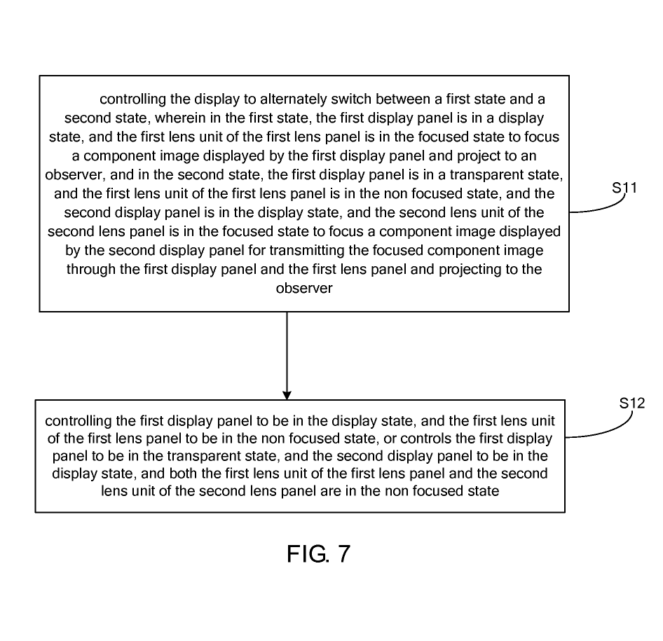

Please refer to FIG. 7. FIG. 7 is a flowchart of a control method of a display switchable between 2D and 3D modes according to the preferred embodiment of the present invention. In this embodiment, the control method is achievable by utilizing the foregoing display. The control method comprises a step of 3D display:

Step S11, controlling the display to alternately switch between a first state and a second state, wherein in the first state, the first display panel is in a display state, and the first lens unit of the first lens panel is in the focused state to focus a element image displayed by the first display panel and project to an observer, and in the second state, the first display panel is in a transparent state, and the first lens unit of the first lens panel is in the non focused state, and the second display panel is in the display state, and the second lens unit of the second lens panel is in the focused state to focus a element image displayed by the second display panel for transmitting the focused element image through the first display panel and the first lens panel and projecting to the observer.

The control method comprises a step of 2D display:

Step S12, controlling the first display panel to be in the display state, and the first lens unit of the first lens panel to be in the non focused state, or controls the first display panel to be in the transparent state, and the second display panel to be in the display state, and both the first lens unit of the first lens panel and the second lens unit of the second lens panel are in the non focused state.

It is understandable that order of the step S11 and S12 can be switched.

The present invention arranges that the first lens panel and the second lens panel respectively comprise the first lens unit and the second lens unit aligned along a predetermined direction, and controls the first lens unit and the second lens unit to switch between the focused state, which can refract the entering light and the non focused state, which do not refract the entering light, and sets the first lens unit and the second lens unit to stagger with each other along the predetermined direction. The resolution and viewing angle of the display can be preferably improved at the same time.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A display switchable between 2D and 3D modes, wherein the display comprises a first lens panel, a first display panel, a second lens panel and a second display panel which sequentially stack-up, wherein the first lens panel and the second lens panel respectively comprise a first lens unit and a second lens unit aligned along a predetermined direction, and the first lens unit and the second lens unit can switch between a focused state, which can refract an entering light and a non focused state, which do not refract the entering light, wherein the first lens unit and the second lens unit stagger with each other along the predetermined direction, and a pitch of the first lens unit and the second lens unit along the predetermined direction are the same, and a staggered distance of the first lens unit and the second lens unit along the predetermined direction is a half of the pitch, and the display further comprises a control unit, and the control unit controls the display to alternately switch between a first state and a second state under the 3D mode, wherein in the first state, the first display panel is in a display state, and the first lens unit of the first lens panel is in the focused state to focus a element image displayed by the first display panel and project to an observer, and in the second state, the first display panel is in a transparent state, and the first lens unit of the first lens panel is in the non focused state, and the second display panel is in the display state, and the second lens unit of the second lens panel is in the focused state to focus a element image displayed by the second display panel for transmitting the focused element image through the first display panel and the first lens panel and projecting to the observer.

2. The display according to claim 1, wherein the first lens panel comprises a first transparent substrate, a second transparent substrate which are oppositely positioned, and a first liquid crystal layer packaged between the first transparent substrate and the second transparent substrate, and the second lens panel comprises a third transparent substrate, a fourth transparent substrate which are oppositely positioned, and a second liquid crystal layer packaged between the third transparent substrate and the fourth transparent substrate, and the first transparent substrate is constructed by connecting a plurality of first curved structures which sections along the predetermined direction are arches, and the third transparent substrate is constructed by connecting a plurality of second curved structures which sections along the predetermined direction are arches, and the first curved structure and the second curved structure stagger along the predetermined direction, and both the first liquid crystal layer and the second liquid crystal layer comprise a plurality of liquid crystal molecules, and a first axis refractive index of the liquid crystal molecules is larger than refractive indexes of the first transparent substrate and the third transparent substrate, and a second axis refractive index of the liquid crystal molecules is equal to the refractive indexes of the first transparent substrate and the third transparent substrate.

3. The display according to claim 2, wherein widths of the first curved structure and the second curved structure along the predetermined direction are equal, and a staggered distance of the first curved structure and the second curved structure along the predetermined direction is a half of the width.

4. The display according to claim 1, wherein the control unit controls the first display panel to be in the display state, and the first lens unit of the first lens panel to be in the non focused state, or controls the first display panel to be in the transparent state, and the second display panel to be in the display state under 2D mode, and both the first lens unit of the first lens panel and the second lens unit of the second lens panel are in the non focused state.

5. The display according to claim 2, wherein the control unit is employed to control the liquid crystal molecules to twist, wherein as a first axis of the liquid crystal molecules is twisted to be parallel with the first display panel, the corresponding first lens unit or the corresponding second lens unit is in the focused state, and as the first axis of the liquid crystal molecules is twisted to be perpendicular with the first display panel, the corresponding first lens unit or the corresponding second lens unit is in the non focused state.

6. The display according to claim 2, wherein the display further comprises a first cell and a second cell, and the first cell is positioned between the first lens panel and the first display panel, and the second cell is positioned between the second lens panel and the second display panel, and the control unit respectively controls polarization states of polarized lights entering the first lens unit and the second lens unit by controlling the first cell and the second cell and accordingly, to control the first lens unit and the second lens unit to switch between the focused state and the non focused state.

7. A display switchable between 2D and 3D modes, wherein the display comprises a first lens panel, a first display panel, a second lens panel and a second display panel which sequentially stack-up, wherein the first lens panel and the second lens panel respectively comprise a first lens unit and a second lens unit aligned along a predetermined direction, and the first lens unit and the second lens unit can switch between a focused state, which can refract an entering light and a non focused state, which do not refract the entering light, wherein the first lens unit and the second lens unit stagger with each other along the predetermined direction.

8. The display according to claim 7, wherein a pitch of the first lens unit and the second lens unit along the predetermined direction are the same, and a staggered distance of the first lens unit and the second lens unit along the predetermined direction is a half of the pitch.

9. The display according to claim 7, wherein the first lens panel comprises a first transparent substrate, a second transparent substrate which are oppositely positioned, and a first liquid crystal layer packaged between the first transparent substrate and the second transparent substrate, and the second lens panel comprises a third transparent substrate, a fourth transparent substrate which are oppositely positioned, and a second liquid crystal layer packaged between the third transparent substrate and the fourth transparent substrate, and the first transparent substrate is constructed by connecting a plurality of first curved structures which sections along the predetermined direction are arches, and the third transparent substrate is constructed by connecting a plurality of second curved structures which sections along the predetermined direction are arches, and the first curved structure and the second curved structure stagger along the predetermined direction, and both the first liquid crystal layer and the second liquid crystal layer comprise a plurality of liquid crystal molecules, and a first axis refractive index of the liquid crystal molecules is larger than refractive indexes of the first transparent substrate and the third transparent substrate, and a second axis refractive index of the liquid crystal molecules is equal to the refractive indexes of the first transparent substrate and the third transparent substrate.

10. The display according to claim 9, wherein widths of the first curved structure and the second curved structure along the predetermined direction are equal, and a staggered distance of the first curved structure and the second curved structure along the predetermined direction is a half of the width.

11. The display according to claim 7, wherein the display further comprises a control unit, and the control unit controls the display to alternately switch between a first state and a second state under the 3D mode, wherein in the first state, the first display panel is in a display state, and the first lens unit of the first lens panel is in the focused state to focus a element image displayed by the first display panel and project to an observer, and in the second state, the first display panel is in a transparent state, and the first lens unit of the first lens panel is in the non focused state, and the second display panel is in the display state, and the second lens unit of the second lens panel is in the focused state to focus a element image displayed by the second display panel for transmitting the focused element image through the first display panel and the first lens panel and projecting to the observer.

12. The display according to claim 11, wherein the control unit controls the first display panel to be in the display state, and the first lens unit of the first lens panel to be in the non focused state, or controls the first display panel to be in the transparent state, and the second display panel to be in the display state under 2D mode, and both the first lens unit of the first lens panel and the second lens unit of the second lens panel are in the non focused state.

13. The display according to claim 9, wherein the display further comprises a control unit, and the control unit is employed to control the liquid crystal molecules to twist, wherein as a first axis of the liquid crystal molecules is twisted to be parallel with the first display panel, the corresponding first lens unit or the corresponding second lens unit is in the focused state, and as the first axis of the liquid crystal molecules is twisted to be perpendicular with the first display panel, the corresponding first lens unit or the corresponding second lens unit is in the non focused state.

14. The display according to claim 9, wherein the display further comprises a control unit, a first cell and a second cell, and the first cell is positioned between the first lens panel and the first display panel, and the second cell is positioned between the second lens panel and the second display panel, and the control unit respectively controls polarization states of polarized lights entering the first lens unit and the second lens unit by controlling the first cell and the second cell and accordingly, to control the first lens unit and the second lens unit to switch between the focused state and the non focused state.

15. A control method of a display switchable between 2D and 3D modes, wherein the display comprises a first lens panel, a first display panel, a second lens panel and a second display panel which sequentially stack-up, wherein the first lens panel and the second lens panel respectively comprise a first lens unit and a second lens unit aligned along a predetermined direction, and the first lens unit and the second lens unit can switch between a focused state, which can refract an entering light and a non focused state, which do not refract the entering light, wherein the first lens unit and the second lens unit stagger with each other along the predetermined direction, and the method comprises:
controlling the display to alternately switch between a first state and a second state, wherein in the first state, the first display panel is in a display state, and the first lens unit of the first lens panel is in the focused state to focus a element image displayed by the first display panel and project to an observer, and in the second state, the first display panel is in a transparent state, and the first lens unit of the first lens panel is in the non focused state, and the second display panel is in the display state, and the second lens unit of the second lens panel is in the focused state to focus a element image displayed by the second display panel for transmitting the focused element image through the first display panel and the first lens panel and projecting to the observer.

16. The control method according to claim 15, wherein the control method further comprises:
controlling the first display panel to be in the display state, and the first lens unit of the first lens panel to be in the non focused state, or controls the first display panel to be in the transparent state, and the second display panel to be in the display state, and both the first lens unit of the first lens panel and the second lens unit of the second lens panel are in the non focused state.
